(19) United States
(12) Patent Application Publication
(10) Pub. No.: US 2005/0004953 A1
(43) Pub. Date: Jan. 6, 2005

(54) Receiving terminal device

(76) Inventor: Hiroyuki Kurase, Asaka-shi (JP)

Correspondence Address: BIRCH STEWART KOLASCH & BIRCH, PO BOX 747, FALLS CHURCH, VA, 22040-0747, US

(21) Appl. No.: 10/878,111

(22) Filed: Jun. 29, 2004

(30) Foreign Application Priority Data
Jul. 1, 2003 (JP) P2003-270112

(51) Int. Cl. G06F 17/30

(52) U.S. Cl. 707/201; 707/10; 707/203

(57) ABSTRACT

A receiving terminal device capable of accessing one of a plurality of screens that has an instruction for performing object processing by sequentially tracing a plurality of hierarchical layers of a menu, comprises: a user interface that displays the plurality of screens that correspond to said plurality of hierarchical layers of the menu; an operation history information storage section that stores operation history information of a user in correspondence with ID information; a tag reader section that receives the ID information from a wireless tag attached to a personal belonging of the user; and a control section that acquires, from the operation history information storage section, operation history information of the user corresponding to the ID information received by the tag reader section and displays on the user interface a screen corresponding to the operation history information.

### BACKGROUND OF THE INVENTION

1. Field of the Invention

The present invention relates to a receiving terminal device having the function of reading image data from a transportable recording medium and printing an image on the basis of the image data, as well as the function of receiving a print order.

2. Description of the Related Art

Some receiving terminals installed in storefronts, such as convenience stores, have the function of a bank ATM (Automatic Teller Machine); the function of selling or reserving various tickets, such as a concert ticket or a transportation ticket; the function of downloading various digital contents, such as music data or image data; the function of printing an image recorded on a transportable recording medium brought by the user; and the function of receiving a print order.

When the user performs certain processing through use of such a multifunctional receiving terminal device, there must be iteratively performed operations for selecting a desired processing content from an initial menu screen of the receiving terminal device; invoking a new screen listing a menu of functions; and selecting a desired processing content on the thus-invoked menu screen.

For instance, when printing of an image recorded on the transportable recording medium is desired, the user must perform complicated operations while tracing a plurality of levels of a hierarchy, such as, the operations of: selecting a print function from among a plurality of functions appearing on an initial menu screen; going to a print receipt menu screen; inserting the transportable recording medium in a medium insert slot; selecting an image desired to be printed on an image selection menu screen; specifying a print medium and the number of prints on a print condition selection menu; and instructing execution of the print processing. Every time the user visits a shop and attempts to perform print processing, the user must perform complicated operations analogous to those mentioned above.

A technique for recording in memory history information about operations performed by the user in the past and jumping to a deep hierarchical level of the menu at a single stroke on the basis of the history information has been known as a related-art technique proposed to solve this type of problem. A method for selecting a menu screen—to which a jump is to be made—includes a method for displaying operation history and prompting the user to select any from the history and a method for automatically selecting a menu on the basis of history information (see JP-A-5-265682, JP-A-5-298377 and JP-A-2002-215278).

However, the techniques described in JP-A-5-265682, JP-A-5-298377 and JP-A-2002-215278 are based on the premise that the same person uses a terminal device at all times. The technique cannot be applied to a terminal device which is to be used by an indefinite number of users, such as a receiving terminal device installed in a storefront such as a convenience store.

### SUMMARY OF THE INVENTION

The present invention has been conceived in view of a drawback of such a related-art technique and aims at providing a receiving terminal device which provides superior operability and can display a screen corresponding to an individual user's operation history even in an environment in which the device is used by an indefinite number of users.

To achieve the object, according to the present invention, there is provided A receiving terminal device capable of accessing one of a plurality of screens that has an instruction for performing object processing by sequentially tracing a plurality of hierarchical layers of a menu, the device comprising: a user interface that displays the plurality of screens that correspond to said plurality of hierarchical layers of the menu; an operation history information storage section that stores operation history information of a user in correspondence with ID information; a tag reader section that receives the ID information from a wireless tag attached to a personal belonging of the user; and a control section that acquires, from the operation history information storage section, operation history information of the user corresponding to the ID information received by the tag reader section and displays on the user interface a screen corresponding to the operation history information.

There is also provided a receiving terminal device capable of accessing one of a plurality of screens that has an instruction for performing object processing by sequentially tracing a plurality of hierarchical layers of a menu, the device comprising: display means for displaying the plurality of screens that correspond to said plurality of hierarchical layers of the menu; operation history information storage means for storing operation history information of a user in correspondence with ID information; ID information receiving means for receiving the ID information from a wireless tag attached to a personal belonging of the user; and control means for acquiring, from the operation history information storage means, operation history information of the user corresponding to the ID information received by the ID information receiving means and for displaying on the display means a screen corresponding to the operation history information.

According to an another aspect of the present invention, there is provided a receiving terminal device capable of accessing one of a plurality of screens that has an instruction for performing object processing by sequentially tracing a plurality of hierarchical layers of a menu, the device comprising: a user interface that displays the plurality of screens that correspond to said plurality of hierarchical layers of the menu; a tag reader section that receives ID information from a wireless tag attached to a personal belonging of a user; and a control section that acquires, from an external device, operation history information of the user corresponding to the ID information received by the tag reader section and displays on the user interface a screen corresponding to the operation history information.

There is also provided a receiving terminal device capable of accessing one of a plurality of screens that has an instruction for performing object processing by sequentially tracing a plurality of hierarchical layers of a menu, the device comprising: display means for displaying the plurality of screens that correspond to said plurality of hierarchical layers of the menu; ID information receiving means for receiving ID information from a wireless tag attached to a personal belonging of a user; and control means for, from an external device, acquiring operation history information of the user corresponding to the ID information received by the ID information receiving means and for displaying on the display means a screen corresponding to the operation history information.

The receiving terminal devices having the foregoing configurations receive ID information from the wireless tag attached to the personal belonging possessed by the user who has approached the receiving terminal device in order to perform an arbitrary operation, thereby displaying a screen corresponding to the user's operation history information associated with the ID information.

Therefore, even in an environment in which the device is used by an indefinite number of users, the receiving terminal device enables display of a screen corresponding to operation history of each user from an initial stage.

In the receiving terminal device, when the control section detects a plurality of wireless tags, the control section acquires the operation history information from a higher-priority one of said plurality of wireless tags.

As mentioned above, as a result of use of the ID information received from the wireless tag having a higher priority, even when the user possesses a plurality of personal belongings equipped with the wireless tags, the chance of being able to display the menu most suitable for the user from the initial stage can be enhanced.

When the plurality of wireless tags are not prioritized, the control section preferably acquires the operation history information from a most-frequently accessed one of the plurality of wireless tags.

As mentioned above, as a result of use of the ID information read from the wireless tag which has been accessed the greatest number of times in the past, even when the user possesses a plurality of personal belongings equipped with the wireless tags and the wireless tags are not prioritized, the chance of being able to display the menu most suitable for the user from the initial stage can be enhanced.

The receiving terminal device of the present invention preferably further comprises: a media interface section that reads image data from one of a transportable recording medium and a digital camera, wherein the control section performs one of (a) producing a print based on the image data and (b) receiving a print order of the image data for an external printer.

There is also provided a receiving terminal device further comprising: means for reading image data from one of a transportable recording medium and a digital camera, wherein the control means performs one of (a) producing a print based on the image data and (b) receiving a print order of the image data for an external printer.

By means of this configuration, when the user—who has performed operation for instructing execution of printing operation or placing a print order in the past—attempts to perform an analogous operation next time, a menu screen for performing an operation for instructing execution of printing operation or placing a print order can be displayed from the initial stage.

In this case, the personal belonging is preferably a digital camera or a transportable medium.

By means of this configuration, ID information is received from a wireless tag provided on a digital camera or transportable recording medium, which is possessed by the user, and a screen—by means of which there is to be performed an operation for instructing execution of printing operation or placing a print order—can be displayed from an initial stage in accordance with the operation history information of the user corresponding to the ID information.

### BRIEF DESCRIPTION OF THE DRAWINGS

FIG. 1 is a functional block diagram showing an example configuration of a receiving terminal device according to the invention;

FIG. 2 is a flowchart illustrating details on operation of the receiving terminal device shown in FIG. 1;

FIG. 3 is a screen transition view showing example transitions from a menu screen to another in the receiving terminal device shown in FIG. 1;

FIG. 4 is a flowchart illustrating details on another operation of the receiving terminal device shown in FIG. 1; and

FIG. 5 is a front view illustrating a case where a wireless tag is incorporated in a digital camera, which is a personal belonging of the user, and in a strap thereof.

### DETAILED DESCRIPTION OF THE INVENTION

An embodiment of the present invention will be described hereinbelow.

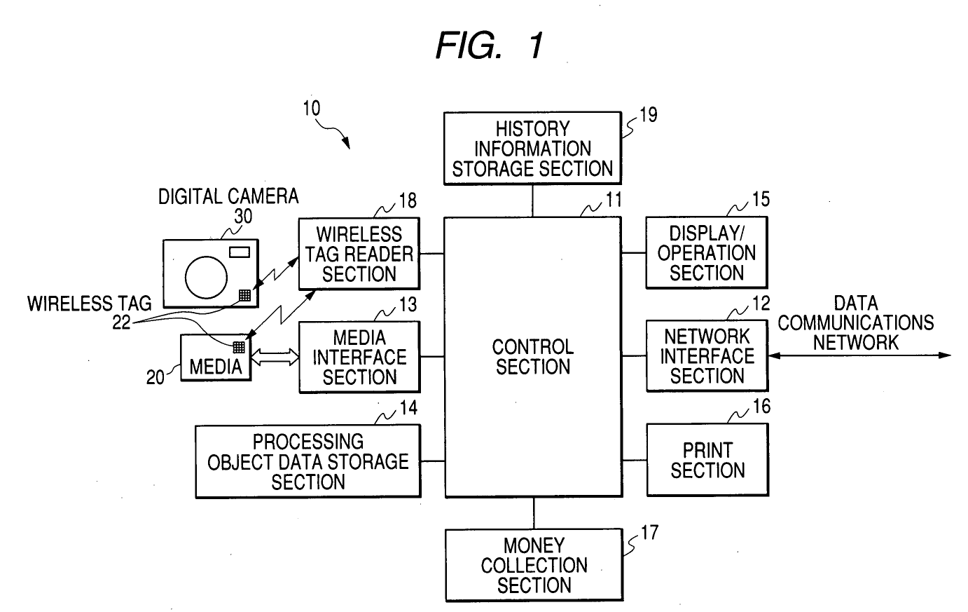

FIG. 1 is a functional block diagram showing an example configuration of a receiving terminal device according to the invention.

A receiving terminal device 10 is a multifunctional receiving terminal device installed in a storefront, such as a convenience store. The receiving terminal device 10 has the functions of: printing of image data recorded in a transportable recording medium brought by the user; receiving a print order; downloading various digital contents such as music data and image data; and selling or reserving various tickets such as a concert ticket or a transportation ticket.

Constituent elements of the receiving terminal device 10 include a control section 11; a network interface (I/F) section 12; a media interface (I/F) section 13; a processing object data storage section 14; a display/operation section 15; a print section 16; a money collection section 17; a wireless tag reader section 18; and a history information storage section 19.

The control section 11 controls the entirety of the receiving terminal device 10, including processing for receiving image data; print processing for local printing of the image data; processing for receiving a print order for external (remote) printing of the image data, preferably at a high performance printer; processing for downloading digital contents (image data, music data); processing for selling tickets; processing for reserving a ticket; charging processing; processing for receiving ID information; processing for identifying a user; and processing for displaying a menu screen. The control section 11 is primarily constituted of a processor which operates in accordance with a program.

For example, but not by way of limitation, the control section that performs the foregoing functions can be a general purpose computer containing a set of instructions for the below-described method of the present invention. As such, the control section may also include a computer-readable medium or a data carrier that contains instructions for performing the method of the present invention.

The network I/F section 12 is a communications interface to be used for downloading various digital contents, such as music data or image data, from a contents server (not shown) by way of a data communications network and for transmitting to a print server (not shown) image data for which a print order has been placed. The high-performance printer (not shown) is connected to the print server, and high-quality print processing can be performed by means of transmitting image data to the print server based on the print order received by the control section 11, as disclosed above.

The media interface section 13 has a slot (insert port) corresponding to various transportable recording media (the transportable recording media will be hereinafter described simply as “media”) 20. The media interface section 13 is a media interface for reading image data from the media 20 inserted into the slot and writing downloaded digital contents in the media. When image data are read directly from a digital camera 30, a cable having a connector capable of connecting with the digital camera 30 is connected to the media interface section 13.

The processing object data storage section 14 is a storage device for storing various processing object data, including image data read from the media 20 or the digital camera 30 and downloaded digital contents, and is constituted of, e.g., a hard disk drive.

The display/operation section 15 is a user interface having both a display function for displaying various operation screens or processing object images to the user and an operation function (input function) by means of which the user issues various commands to the receiving terminal device 10. The display/operation section 15 is constituted of, e.g., a liquid-crystal display device equipped with touch sensors. However, the display/operation section of the present invention that performs the above-described function(s) is not limited to a liquid-crystal display, and may also include other user interfaces that are well-known in the art, such as a standard CRT display or the like, or even a three-dimensional projected display. The various operation screens include a main menu screen (a function selection screen) for causing the user to select a desired function from among various processing functions of the receiving terminal device 10; that is, print processing; processing for receiving a print order; processing for downloading digital contents; processing for selling a ticket; and processing for reserving a ticket. As a result of a desired function having been selected from among the functions appearing on the main menu screen (i.e., as a result of the user having touched an area where a desired function item is displayed), the user can go to a desired operation screen listing a menu of functions. Each operation screen further includes a menu screen comprising a plurality of hierarchical layers, and a screen to be used for instructing execution of desired processing can be reached by means of sequentially tracing menus.

The print section 16 is for performing simplified printing of an image on the basis of the image data stored in the processing object data storage section 14. This print section 16 is utilized when the user desires to immediately acquire prints of image data recorded in the media 20 or the digital camera 30 or prints of downloaded image data.

The money collection section 17 determines the denominations of inserted coins or bills, calculates the total value of the inserted coins or bills, and is used for collecting a charge incurred as a result of use of the receiving terminal device 10.

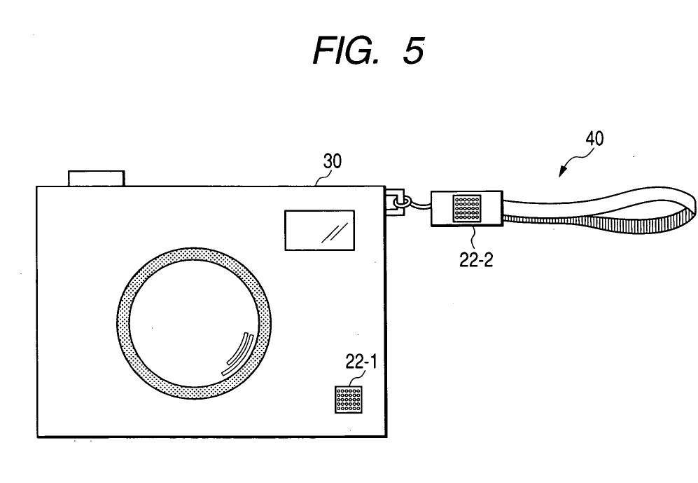

The wireless tag reader section 18 is ID information receiving means for receiving ID information from a wireless tag 22 attached to a personal belonging of the user. The wireless tag reader section 18 is formed from RF-ID readers provided on respective slots of the media interface section 13 and on the front of a main body of the receiving terminal device 10 (i.e., the area of the main body facing the user). However, other well-known structures for performing the above-described receiving function may also be employed. For example, but not by way of limitation, any sensor that receives information based on an input, such as a wavelength-based and/or optical transmission, may be employed as a structure for achieving the above-described function. The RF-ID readers provided in the respective slots are configured so as to be able to communicate with the wireless tags 22 built in the media 20 inserted in each slot, to thus read ID information recorded in memory provided in the wireless tag 22. The RF-ID reader provided on the front of the main body of the receiving terminal device 10 can communicate with the wireless tag 22 incorporated in the user's digital camera (including a portable cellular phone having the function of a digital camera or the like) 30 or the wireless tag 22 incorporated in a strap 40 (see FIG. 5), to thus read ID information recorded in the memory provided in the wireless tag 22. However, the digital camera or media to be used for giving image data to the receiving terminal device is not limited to the digital camera or media to which the wireless tag is attached, and may also include a digital camera or transportable recording media to which the wireless tag is not attached.

The history information storage section 19 is a storage device storing history information about users' operations in association with ID information and is constituted of, e.g., a hard disk drive. However, the storage device that performs the function of storing history information is not limited to a hard disk drive, and any well-known equivalent information storage structure may be employed. For example, but not by way of limitation, an optical or magnetic disk, a portable memory storage device such as a memory stick but not limited thereto, a remote data storage system, or other data storage structure as would be known to one of ordinary skill in the art may be employed.

Next, operation of the receiving terminal device 10 shown in FIG. 1 will be described, with emphasis placed on operations for controlling and displaying an operation screen.

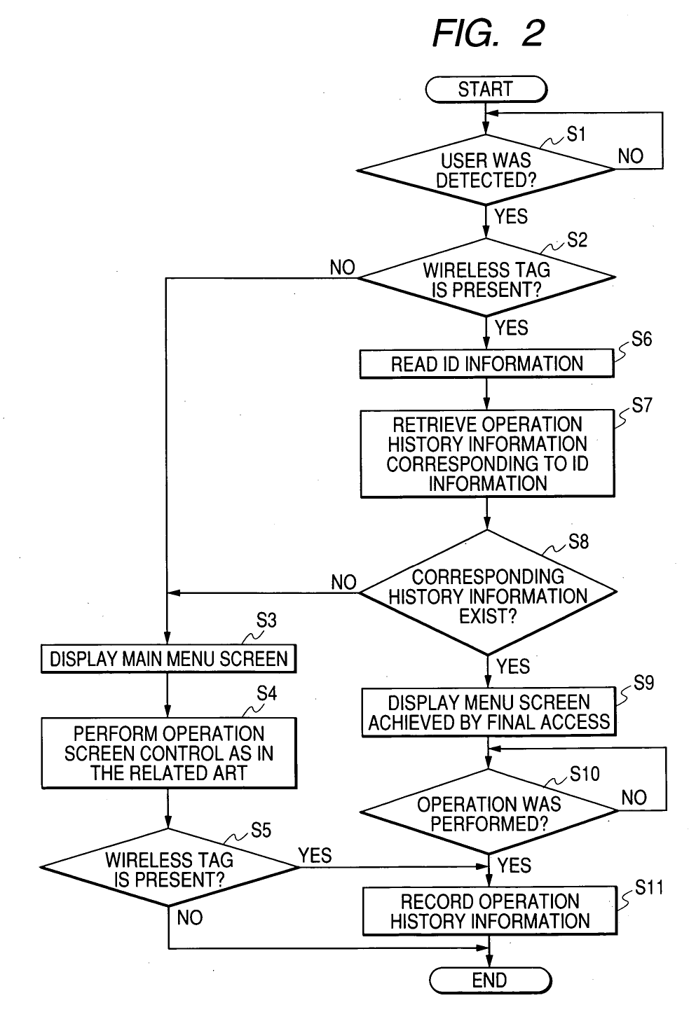

FIG. 2 is a flowchart illustrating details on the operation of the receiving terminal device 10 shown in FIG. 2.

Upon detection of a user (i.e., an operator) who attempts to start operation (when YES is selected in S1); that is, upon detection of a touch on the display/operation section 15 or detection of a person approaching a predetermined range by means of an unillustrated sensor, the receiving terminal device 10 activates the wireless tag reader section 18, to thus detect presence or absence of the wireless tag 22 provided on personal belongings of the user (S2).

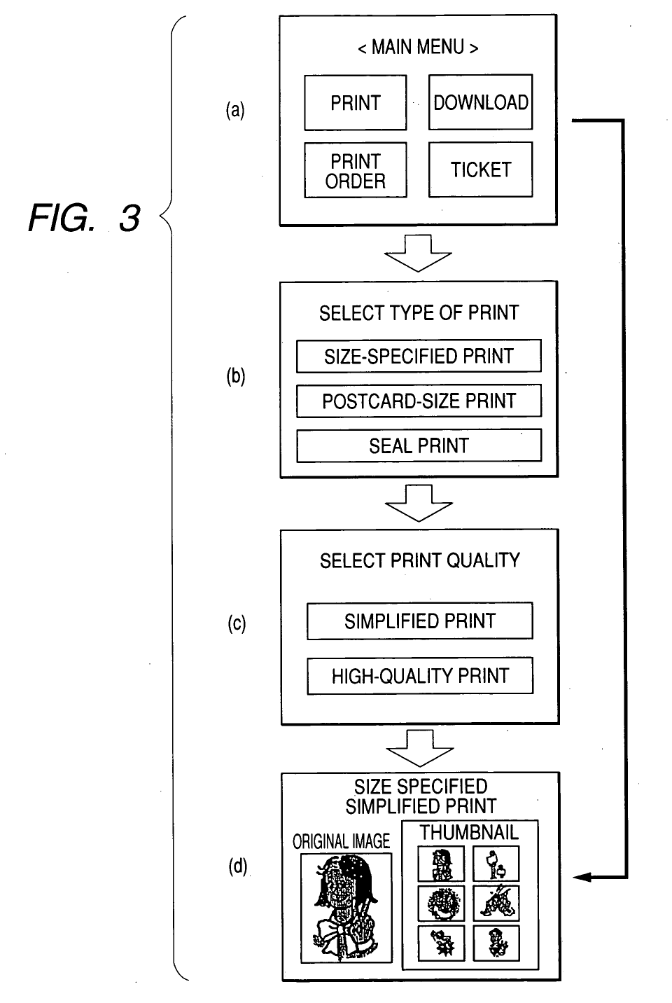

If the wireless tag has not been detected (when NO is selected in S2), a main menu screen (see (a) of FIG. 3) is displayed on the display/operation section 15 (S3). In this case, the user initiates operation by way of the main menu screen, to thus perform operations, such as selecting from menu screens according to processing contents, as in the related-art receiving terminal device (S4).

Upon detection of the wireless tag 22 (when YES is selected in S2), the ID information is read from the wireless tag 22 (S6), and history information about operations of the user corresponding to the thus-read ID information is retrieved from the information recorded in the history information storage section 19 (S7). Consequently, if corresponding operation history information is not recorded in the history information storage section 19 (when NO is selected in S8), processing proceeds to steps S3, S4. In this case, since the wireless tag 22 has been detected (when YES has been selected in S5), operation history information is recorded in the history information storage section 19 in correspondence with the ID information read in step S6 (S11).

When corresponding operation history information is recorded (when YES is selected in S8), a menu screen achieved by final access of the user (i.e., the previous operation of the user) is displayed on the display/operation section 15 on the basis of the operation history information (S9). Specifically, on the basis of the operation history information a jump is made, by a single stroke, to a deep hierarchical layer of the menu. In this case, the user can initiate operation from the menu screen on which the user has finally performed operation when having visited the shop the last time.

If a new operation has been performed by the user by way of step S9 (when YES has been selected in S10), operation history information pertaining to the new operation is recorded in the history information storage section 19 in correspondence with the ID information (S11: updating of operation history information).

FIGS. 3A to 3D are screen transition diagrams showing example transitions from one menu screen to another on the receiving terminal device 10.

(a) of FIG. 3 illustrates a main menu screen. When the user does not have any belongings equipped with the wireless tag 22 (when NO is selected in step S2 shown in FIG. 2) or when operation history information about that user is not recorded (when NO is selected in step S8 shown in FIG. 2), this main menu screen appears on the display/operation section 15 as an initial screen which appears after detection of a user. A plurality of item buttons, such as “PRINT,” “PRINT ORDER,” “DOWNLOAD,” and “TICKET,” appear on the main menu screen. “PRINT” is a button to be used for going to a sub-menu screen ((b) of FIG. 3) of print processing, and “PRINT ORDER” is a button to be used for going to a sub-menu screen of print order. “DOWNLOAD” is a button to be used for going to a sub-menu screen for downloading various digital contents. “TICKET” is a button to be used for going to a sub-menu screen for placing an order for a ticket or reserving a ticket.

If the user possesses a belonging equipped with the wireless tag 22 (when YES is selected in step S2 shown in FIG. 2) and when operation history information corresponding to the ID information about the wireless tag 22 is recorded in the history information storage section 19 (when YES is selected in step S8 shown in FIG. 2), on the basis of the operation history information a jump is made, by a single stroke, to a deep hierarchical level. For instance, when the user selected a size-specified print last time and performed simplified printing (i.e., printing operation to be performed by the print section 16), there is performed processing for displaying from the outset a menu screen for a size-specified simplified printing illustrated in (d) of FIG. 3 at a point in time when the medium 20 is inserted into the slot of the media interface section 13, by means of skipping a menu screen for selecting the type of a print illustrated in (b) of FIG. 3 or a menu screen for selecting print quality illustrated in (c) of FIG. 3. A thumbnail of the image data recorded on the media 20 and a first image are displayed on the menu screen shown in (d) of FIG. 3.

As mentioned above, the receiving terminal device 10 of the present embodiment receives ID information from the wireless tag 22 attached to the personal belonging of the user who has approached the receiving terminal device 10 in order to perform an arbitrary operation, thereby displaying a screen corresponding to the user's operation history information associated with the ID information.

Therefore, even in an environment in which the receiving terminal device 10 is used by an indefinite number of users, the receiving terminal device 10 enables display of a screen corresponding to operation history of each user from an initial stage. Therefore, the user does not need to perform complicated operations which trace a plurality of hierarchical layers of a menu every time the user visits a shop and attempts to perform desired operation.

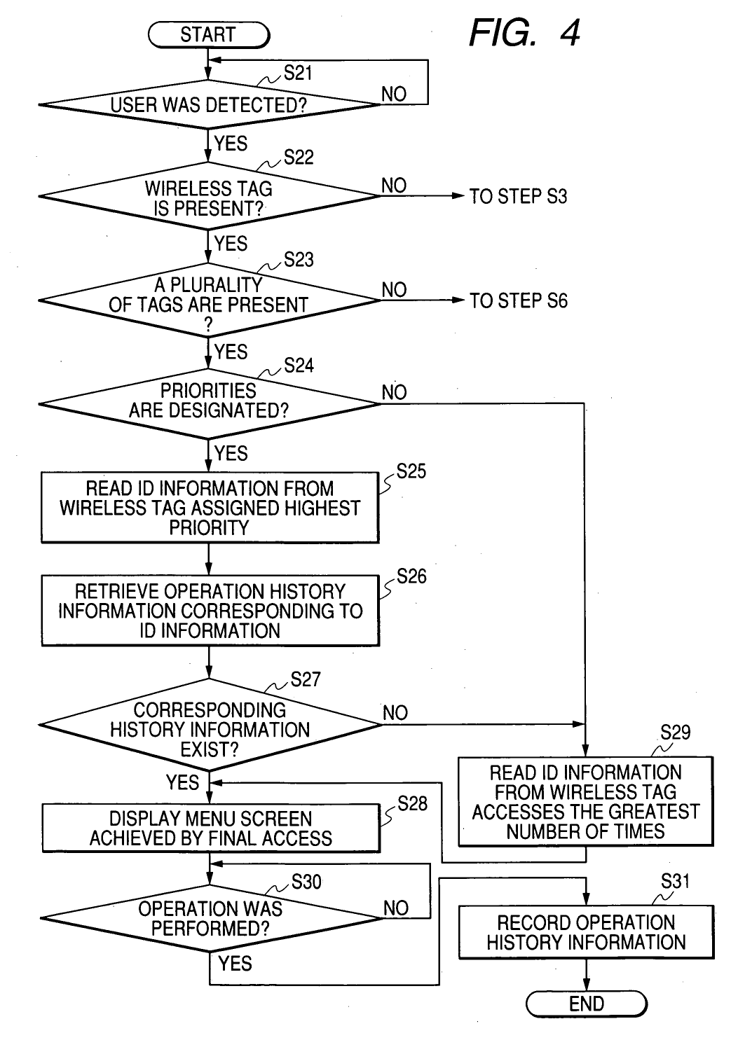

FIG. 4 is a flowchart illustrating details on operation performed when the user who attempts to operate and use the receiving terminal device 10 has a plurality of personal belongings equipped with wireless tags. FIG. 5 illustrates a case where the user has a plurality of personal belongings equipped with wireless tags. In the embodiment shown in FIG. 5, the digital camera 30 and the strap 40 thereof are provided with built-in wireless tags 22 (i.e., 22-1, 22-2), respectively.

In the operation example shown in FIG. 4, upon detection of a user (person) who attempts to initiate operation (when YES is selected in S21), the receiving terminal device 10 activates the wireless tag reader section 18, to thus detect presence or absence of the wireless tags 22 provided on the personal belongings of the user (S22).

If the wireless tags have not been detected (when NO is selected in S22), processing proceeds to step S3 shown in FIG. 2, where the main menu screen is displayed on the display/operation section 15.

If the wireless tag 22 has been detected (when YES has been selected in S22) and the thus-detected tag corresponds to one wireless tag 22 (when NO is selected in S23), processing proceeds to step S6 shown in FIG. 2. If the detected wireless tag 22 corresponds to a plurality of wireless tags 22 (when YES is selected in S23), a determination is made as to whether or not the wireless tags 22 are prioritized (S24). There may be a case where prioritization is determined on the basis of priority information written in the memory provided in each wireless tag 22 along with ID information, and there may be another case where prioritization is to be determined by the receiving terminal device 10. When the receiving terminal device 10 is to determine prioritization, the type of the wireless tag 22 conforming to the function of the receiving terminal device 10 is given a high priority. For instance, when the receiving terminal device 10 is a machine specifically designed to receive a print order, a priority is given to the wireless tag 22 in which attribute information showing a digital camera is written.

When priorities are assigned to the wireless tags 22 (when YES is selected in S24), ID information is read from the wireless tag 22 assigned the highest priority from among the wireless tags 22 (S25), and operation history information of the user corresponding to the thus-read ID information is retrieved from the information recorded in the history information storage section 19 (S26). Consequently, when the operation history information corresponding to the history information storage section 19 is recorded (when YES is selected in S27), a menu screen achieved when the user made the final access is displayed on the display/operation section 15 on the basis of the operation history information (S28).

When the wireless tags 22 are not assigned priorities ((when NO is selected in S24) or when operation history information corresponding to the ID information read from the highest-priority wireless tag 22 is not recorded (when NO is selected in S27), ID information is read from the wireless tag 22 which has been accessed the greatest number of times (i.e., has been detected the greatest number of times) in the past (S29). On the basis of the operation history information of the user corresponding to the thus-read ID information, the menu screen achieved by the user through final access is displayed on the display/operation section 15 (S28).

If the user has performed new operation by way of step S28 (i.e., when YES is selected in S30), operation history information about that new operation is recorded in the history information storage section 19 in correspondence to the ID information (S31 updating of operation history information).

As mentioned above, when the plurality of wireless tags 22 are assigned priorities, ID information is read from a higher-priority wireless tag 22. When the wireless tags 22 are not assigned priorities, ID information is read from the wireless tag 22 which has been accessed the greatest number of times in the past. On the basis of the operation history information of the user corresponding to the thus-read ID information, the menu screen achieved when the user made the final access is displayed on the display/operation section 15. As a result, even when the user possesses a plurality of personal belongings equipped with the wireless tags 22, the chance of being able to display the menu most suitable for the user from the initial stage can be enhanced.

In the embodiment, even when the operation history information of the user corresponding to the ID information read from the wireless tag 22 provided on the personal belonging of the operator is recorded in the history information storage section 19, the operator is not always the valid user corresponding to the ID information (i.e., the person who performed operation last time). For this reason, the operator is requested to enter a pass code. Only when the operator can be identified as the valid user by means of the entered pass code and the ID information, the menu screen achieved by the final access is preferably displayed from the initial stage.

If the operator has been identified as a valid user, it is preferable for the receiving terminal device 10 to automatically perceive, as personal data pertaining to the operator, personal data entered by the user in the past, such as an address, a phone number, or a bank account into which a payment is to be deposited. As a result, the user can omit the laborious efforts which would otherwise be required in various steps; that is, repeated entry of personal data such as an address, a phone number, and a bank account to which a payment is to be deposited.

For instance, if arrangements have been made such that, when the digital camera 30 or the medium 20, which is equipped with the wireless tag 22, is caused to approach the receiving terminal device 10, a menu screen achieved by the final access appears, or if arrangements have been made such that, when a pass code is entered after details to be performed, such as a print order, have been confirmed, the address and phone number of the user appears along with a scheduled receipt date and place, whereby a print order can be placed very quickly.

In the foregoing embodiment, the wireless tag 22 is incorporated in the medium 20 and the digital camera 30. However, the wireless tag 22 can be manufactured to have a size as small as a sesame seed, and hence the wireless tag 22 may be affixed to the medium 20 or the digital camera 30 while being held by an adhesive seal.

In the foregoing embodiment, the receiving terminal device is configured such that the operation history information of the user corresponding to the ID information read from the wireless tag 22 is retrieved from the information recorded in the history information storage section 19 provided in the receiving terminal device 10. However, the function of the history information storage section 19 may be imparted to an external device, and access may be made to the external device by way of a network.

As has been described, even in an environment in which the receiving terminal device is used by an indefinite number of users, the receiving terminal device enables display of a screen corresponding to operation history of each user from an initial stage.

The entire disclosure of each and every foreign patent application from which the benefit of foreign priority has been claimed in the present application is incorporated herein by reference, as if fully set forth.

1. A receiving terminal device capable of accessing one of a plurality of screens that has an instruction for performing object processing by sequentially tracing a plurality of hierarchical layers of a menu, the device comprising:
a user interface that displays the plurality of screens that correspond to said plurality of hierarchical layers of the menu;
an operation history information storage section that stores operation history information of a user in correspondence with ID information;
a tag reader section that receives the ID information from a wireless tag attached to a personal belonging of the user; and
a control section that acquires, from the operation history information storage section, operation history information of the user corresponding to the ID information received by the tag reader section and displays on the user interface a screen corresponding to the operation history information.

2. A receiving terminal device capable of accessing one of a plurality of screens that has an instruction for performing object processing by sequentially tracing a plurality of hierarchical layers of a menu, the device comprising:
a user interface that displays the plurality of screens that correspond to said plurality of hierarchical layers of the menu;
a tag reader section that receives ID information from a wireless tag attached to a personal belonging of a user; and
a control section that acquires, from an external device, operation history information of the user corresponding to the ID information received by the tag reader section and displays on the user interface a screen corresponding to the operation history information.

3. The receiving terminal device according to claim 1, wherein, when the control section detects a plurality of wireless tags, the control section acquires said operation history information from a higher-priority one of said plurality of wireless tags.

4. The receiving terminal device according to claim 3, wherein, when the plurality of wireless tags are not prioritized, the control section acquires said operation history information from a most-frequently accessed one of the plurality of wireless tags.

5. The receiving terminal device according to claim 2, wherein, when the control section detects a plurality of wireless tags, the control section acquires said operation history information from a higher-priority one of said plurality of wireless tags.

6. The receiving terminal device according to claim 5, wherein, when the plurality of wireless tags are not prioritized, the control section acquires said operation history information from a most frequently accessed one of the plurality of wireless tags.

7. The receiving terminal device according to claim 1, further comprising:
a media interface section that reads image data from one of a transportable recording medium and a digital camera, wherein the control section performs one of (a) producing a print based on the image data and b) receiving a print order of the image data for an external printer.

8. The receiving terminal device according to claim 7, wherein the personal belonging of the user to which the wireless tag is attached is said one of the transportable recording medium and the digital camera.

9. The receiving terminal device according to claim 7, wherein the wireless tag is not attached to said one of the transportable recording medium and the digital camera.

10. The receiving terminal device according to claim 2, further comprising:
a media interface section that reads image data from one of a transportable recording medium and a digital camera; and
wherein the control section performs one of (a) producing a print based on the image data and b) receiving a print order of the image data for an external printer.

11. The receiving terminal device according to claim 10, wherein the personal belonging of the user to which the wireless tag is attached is said one of the transportable recording medium and the digital camera.

12. The receiving terminal device according to claim 10, wherein the wireless tag is not attached to said one of the transportable recording medium and the digital camera.

13. A receiving terminal device capable of accessing one of a plurality of screens that has an instruction for performing object processing by sequentially tracing a plurality of hierarchical layers of a menu, the device comprising:
display means for displaying the plurality of screens that correspond to said plurality of hierarchical layers of the menu;
operation history information storage means for storing operation history information of a user in correspondence with ID information;
ID information receiving means for receiving the ID information from a wireless tag attached to a personal belonging of the user; and
control means for acquiring, from the operation history information storage means, operation history information of the user corresponding to the ID information received by the ID information receiving means and for displaying on the display means a screen corresponding to the operation history information.

14. The receiving terminal device according to claim 13, further comprising:
means for reading image data from one of a transportable recording medium and a digital camera; and
wherein the control means performs one of (a) producing a print based on the image data and (b) receiving a print order of the image data for an external printer.

15. A receiving terminal device capable of accessing one of a plurality of screens that has an instruction for performing object processing by sequentially tracing a plurality of hierarchical layers of a menu, the device comprising:
display means for displaying the plurality of screens that correspond to said plurality of hierarchical layers of the menu;
ID information receiving means for receiving ID information from a wireless tag attached to a personal belonging of a user; and
control means for, from an external device, acquiring operation history information of the user corresponding to the ID information received by the ID information receiving means and for displaying on the display means a screen corresponding to the operation history information.

16. The receiving terminal device according to claim 15, further comprising:
means for reading image data from one of a transportable recording medium and a digital camera; and
wherein the control means performs one of (a) producing a print based on the image data and (b) receiving a print order of the image data for an external printer.

17. The device of claim 1, wherein said user interface is a liquid crystal display device.

18. The device of claim 1, wherein said operation history information storage section is a hard disk drive.

19. The device of claim 1, wherein said tag reader section is a wireless RF/ID device.

20. The device of claim 2, wherein said user interface is a liquid crystal display device.

21. The device of claim 2, wherein said tag reader section is a wireless RF/ID device.
